(19) United States
(12) Patent Application Publication
(10) Pub. No.: US 2022/0067729 A1
(43) Pub. Date: Mar. 3, 2022

(54) INFORMATION PROVIDING APPARATUS AND NON-TRANSITORY COMPUTER READABLE MEDIUM STORING INFORMATION PROVIDING PROGRAM

(71) Applicant: JVCKENWOOD Corporation, Yokohama-shi (JP)

(72) Inventors: Masashi UEMOTO, Yokohama-shi (JP); Toru KAIWA, Yokohama-shi (JP); Masaki TAKEI, Yokohama-shi (JP); Misa SUZUKI, Yokohama-shi (JP); Hiromitsu ASAKA, Yokohama-shi (JP); Aki HAMADA, Yokohama-shi (JP); Miharu KOBAYASHI, Yokohama-shi (JP)

(73) Assignee: JVCKENWOOD Corporation

(21) Appl. No.: 17/461,743

(22) Filed: Aug. 30, 2021

(30) Foreign Application Priority Data
Aug. 31, 2020 (JP) 2020-145806

(51) Int. Cl. G06Q 20/40; G06Q 20/16; B60W 50/14; G06K 9/00

(52) U.S. Cl. CPC G06Q 20/401; G06Q 20/16; B60W 2050/146; G06K 9/00791; B60W 2420/42; B60W 50/14

(57) ABSTRACT

An information providing apparatus according to an embodiment includes: notification reception means for receiving a notification indicating that provision of information about a captured video image of a dashboard camera to a user is permitted, the dashboard camera being mounted on a vehicle; information acquisition means for acquiring the information about the captured video image of the dashboard camera, provision of the captured video image to the user having been permitted; information output means for providing, to the user who requests provision of the information about the captured video image acquired by the information acquisition means, the information about the captured video image; and payment means for paying a remuneration to an owner of the dashboard camera that has captured the video image, provision of the video image to the user having been permitted.

### CROSS REFERENCE TO RELATED APPLICATION

This application is based upon and claims the benefit of priority from Japanese patent application No. 2020-145806, filed on Aug. 31, 2020, the disclosure of which is incorporated herein in its entirety by reference.

### BACKGROUND

The present disclosure relates to an information providing apparatus and an information providing program and, for example, to an information providing apparatus and an information providing program that are suitable for efficiently collecting information to be provided to a user.

Development of an information providing system for collecting images taken by a plurality of dashboard cameras mounted on a plurality of respective vehicles and providing the collected images to users has advanced.

For example, the dashboard camera information providing system disclosed in Japanese Patent No. 6448872 acquires, from each of a plurality of dashboard cameras, feature information of the image taken when an occurrence of a predetermined event is detected from among the images taken by the dashboard camera, and provides information generated based on the acquired feature information to an external server such as a traffic information server. It should be noted that this dashboard camera information providing system includes payment means for paying a remuneration to a manager of a vehicle equipped with a dashboard camera that has captured the image on which the information provided to an external server is based.

### SUMMARY

However, in the configuration disclosed in Japanese Patent No. 6448872, a remuneration is paid only to a manager of a vehicle equipped with a dashboard camera that has captured the image on which the information provided to an external server is based, and no remuneration is paid to a manager of a vehicle quipped with a dashboard camera that has captured an image other than the former image.

Thus, for example, it is highly likely that a remuneration is paid only to a manager of a vehicle equipped with a dashboard camera that has captured an image of great rarity, such as an image related to a traffic accident, and that no remuneration is paid to a manager of a vehicle equipped with a dashboard camera that has captured an image other than the former image.

Therefore, the configuration disclosed in Japanese Patent No. 6448872 has a problem that the number of people who provide images captured by dashboard cameras does not increase, and consequently information to be provided to an external server cannot be efficiently collected.

An information providing apparatus according to an aspect of an embodiment includes: notification reception means for receiving a notification indicating that provision of information about a captured video image of an image capturing apparatus to a user is permitted, the image capturing apparatus being held by a mobile body; information acquisition means for acquiring the information about the captured video image of the image capturing apparatus, provision of the captured video image to the user having been permitted; information output means for providing, to the user who requests provision of the information about the captured video image acquired by the information acquisition means, the information about the captured video image; and payment means for paying a remuneration to an owner of the image capturing apparatus that has captured the video image, provision of the video image to the user having been permitted.

An information providing program according to an aspect of an embodiment causes a computer to: receive a notification indicating that provision of information about a captured video image of an image capturing apparatus to a user is permitted, the image capturing apparatus being held by a mobile body; acquire the information about the captured video image of the image capturing apparatus, provision of the captured video image to the user having been permitted; provide, to the user who requests provision of the acquired information about the captured video image, the acquired information about the captured video image; and pay a remuneration to an owner of the image capturing apparatus that has captured the video image, provision of the video image to the user having been permitted.

### BRIEF DESCRIPTION OF THE DRAWINGS

The above and other aspects, advantages and features will be more apparent from the following description of certain embodiments taken in conjunction with the accompanying drawings, in which:

FIG. 1 is a block diagram showing a configuration example of an information providing system according to a first embodiment;

FIG. 2 is a diagram showing an example of restrictions of information about a captured video image acquired by information acquisition means;

FIG. 3 is a block diagram showing a configuration example of a dashboard camera provided in each vehicle of the information providing system according to the first embodiment;

FIG. 4 is a flowchart showing an operation of collecting information performed by the information providing apparatus provided in the information providing system according to the first embodiment;

FIG. 5 is a flowchart showing an operation of the dashboard camera provided in each vehicle of the information providing system according to the first embodiment;

FIG. 6 is a flowchart showing an operation of providing information performed by the information providing apparatus provided in the information providing system according to the first embodiment; and

FIG. 7 is a block diagram showing an example of a hardware configuration of an information providing function of the information providing apparatus provided in the information providing system according to the first embodiment.

### DETAILED DESCRIPTION

A specific embodiment to which the present disclosure is applied will be described hereinafter in detail with reference to the drawings. The same elements are denoted by the same reference symbols throughout the drawings, and redundant descriptions will be omitted as necessary for the sake of clarity.

### First Embodiment

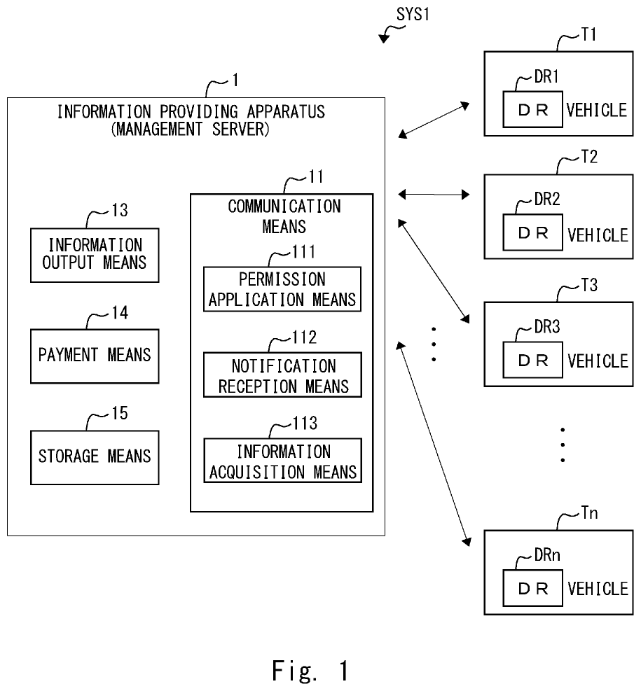

FIG. 1 is a block diagram showing a configuration example of an information providing system SYS1 according to a first embodiment. The information providing system SYS1 according to this embodiment is a system for collecting video images captured by a plurality of dashboard cameras and providing the collected video images to users of this system, in which a fixed remuneration is paid to a provider of the video image captured by the dashboard camera regardless of whether the captured video image has been actually provided to the user. By this configuration, it is highly likely that the number of providers of video images captured by the dashboard cameras increases, and therefore it is possible to efficiently collect information provided to users of this system. The details thereof will be described below.

As shown in FIG. 1, the information providing system SYS1 includes an information providing apparatus 1 and dashboard cameras DR1 to DRn mounted on respective vehicles T1 to Tn (n is an integer equal to or greater than one).

The information providing apparatus 1 is a management server, including, for example, communication means (a communication unit) 11, information output means (an information output unit) 13, and payment means (a payment unit) 14. Further, the communication means 11 includes permission application means (a permission application unit) 111, notification reception means (a notification reception unit) 112, and information acquisition means (an information acquisition unit) 113.

The permission application means 111 applies to an owner of a dashboard camera of each vehicle for permission to use information about the video image captured by the dashboard camera. The application for permission to use the information may be made not only to the owner of the dashboard camera but also to a driver and a passenger of each vehicle. The information about a captured video image may include not only the captured video image but also the capturing position and the capturing time associated with the captured video image. Further, the information about a captured video image may include feature information, such as other vehicles, buildings, backgrounds, and traffic accidents which are in the captured video image. The feature information may be extracted by analyzing the captured video image. The extraction of the feature information may be performed in a dashboard camera or in the information providing apparatus 1. The feature information may include information acquired from inside or outside a dashboard camera, using an acceleration sensor, a gyro sensor, a GPS, a thermometer, a barometer, or the like.

Note that when the permission application means 111 does not need to apply for permission to use information about the captured video image, for example, when a purchaser (an owner) of a dashboard camera is to send a notification about whether or not to permit the use of the information about the captured video image at the time of purchase of the dashboard camera, the permission application means 111 may not be provided.

The notification reception means 112 receives, from an owner of a dashboard camera of each vehicle, a notification indicating that the use of information about the video image captured by the dashboard camera is permitted. In this embodiment, a description will be given of an example in which the notification reception means 112 has received a notification indicating that the use of information about the video image captured by each of the dashboard cameras DR1 to DRn is permitted. The identification information of each of the dashboard cameras DR1 to DRn in which the use of the information about the captured video image has been permitted is stored, for example, in storage means 15.

Note that, in the information about the captured video image, the owner of each of the dashboard cameras DR1 to DRn can freely set a range of information that can be provided to a user. For example, with regard to the captured video image that can be provided to a user, the owner of each of the dashboard cameras DR1 to DRn can set a capturing time period, a capturing area, the number of cameras used for capturing, a frequency of transmission to the information providing apparatus 1, and the like.

The information acquisition means 113 acquires information about the captured video image of each of the dashboard cameras DR1 to DRn, for example, by radio communication. The information about the captured video image of each of the dashboard cameras DR1 to DRn is stored, for example, in the storage means 15.

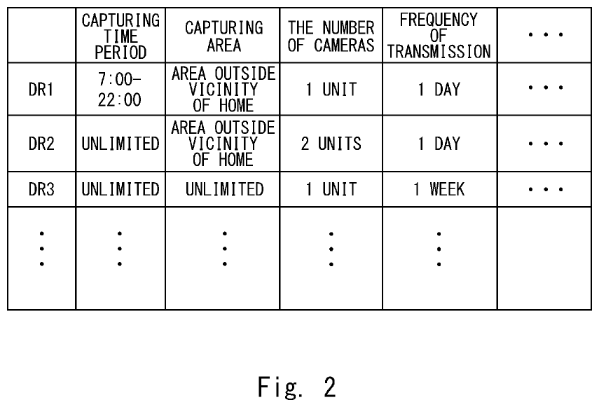

FIG. 2 is a diagram showing an example of restrictions of information about the captured video image acquired by the information acquisition means 113. Referring to FIG. 2, regarding the dashboard camera DR1, the capturing time period is set to a time period from 7 o'clock to 22 o'clock, the capturing area is set to an area outside the vicinity of home, the number of cameras used for capturing is set to one, which camera is a camera that captures the area in the direction to the front of the vehicle, and the frequency of transmitting information about the captured video image to the information providing apparatus 1 is set to once a day. Regarding the dashboard camera DR2, the capturing time period is set to be unlimited (all the time), the capturing area is set to be an area outside the vicinity of home, the number of cameras used for capturing is set to two in total, which cameras are a camera that captures the area in the direction to the front of the vehicle and a camera that captures the area in the direction to the rear of the vehicle, and the frequency of transmitting information about the captured video image to the information providing apparatus 1 is set to once a day. Regarding the dashboard camera DR3, the capturing time period is set to be unlimited (all the time), the capturing area is set to be unlimited, the number of cameras used for capturing is set to one, which camera is a camera that captures the area in the direction to the front of the vehicle, and the frequency of transmitting information about the captured video image to the information providing apparatus 1 is set to once a week.

The information output means 13 provides a user of the information providing system SYS1 who requests provision of information about the captured video image acquired by the information acquisition means 113 with the information about the captured video image which falls within the scope of the user's use authority. The user may be, for example, an external server of a police department, an insurance company, a traffic information provider, or the like, and a general user.

The payment means 14 pays a remuneration in an amount determined in accordance with a range of information that can be provided to a person (the owner of the dashboard camera) who has permitted provision of information about the image captured by the dashboard camera to a user of the information providing system SYS1. Specifically, the payment means 14 pays a remuneration in an amount determined in accordance with a range of information that can be provided into the bank account of a person who has permitted provision of the information about the image captured by the dashboard camera to a user of the information providing system SYS1. The payment means 14 may give a remuneration not only by cash through a bank transfer but also by electronic money or points. Note that the remuneration is not limited to money, but may be, for example, a reduction and a refund of a purchase price, a communication fee, an insurance fee, and the like of the dashboard camera, an increase in a discount rate, and upgrades of products and services.

The dashboard cameras DR1 to DRn are image capturing apparatuses mounted on the respective vehicles T1 to Tn for the purpose of, for example, recording the situation in the event of an accident. In this embodiment, information about the captured video image of each of the dashboard cameras DR1 to DRn is used as information that can be provided to a user of the information providing system SYS1.

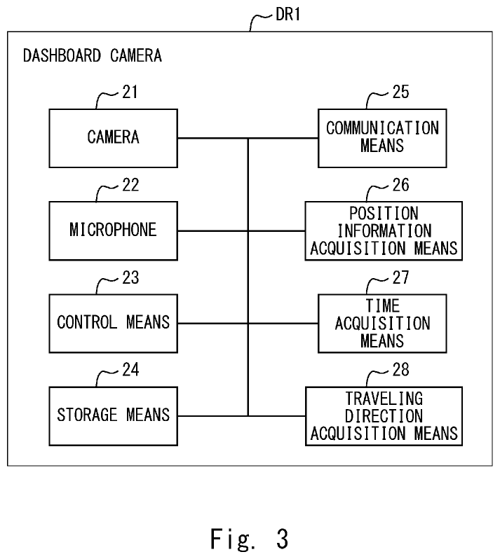

FIG. 3 is a block diagram showing a configuration example of the dashboard camera DR1. Note that a configuration example of each of the dashboard cameras DR2 to DRn is the same as that of the dashboard camera DR1, the description thereof is thus omitted.

As shown in FIG. 3, the dashboard camera DR1 includes a camera 21, a microphone 22, control means 23, storage means 24, communication means 25, position information acquisition means 26, time acquisition means 27, and traveling direction acquisition means 28.

The camera 21 captures a specified area outside a vehicle. The microphone 22 acquires audio information in a specified area outside the vehicle. The position information acquisition means 26 acquires position information of the vehicle by using GPS or the like. The time acquisition means 27 acquires information about the time (the capturing time) at which the capturing by the camera 21 is performed. The traveling direction acquisition means 28 acquires information about the traveling direction of the vehicle which is traveling. The control means 23 controls an operation of each component of the dashboard camera DR1. Further, the captured video image, the audio information, the position information, the time information, and the information about the traveling direction are associated with (i.e., related to) one another and stored in the storage means 24. The communication means 25 communicates with an apparatus (e.g., the information providing apparatus 1) external to the dashboard camera DR1.

### (Operation of Information Providing System SYS1)

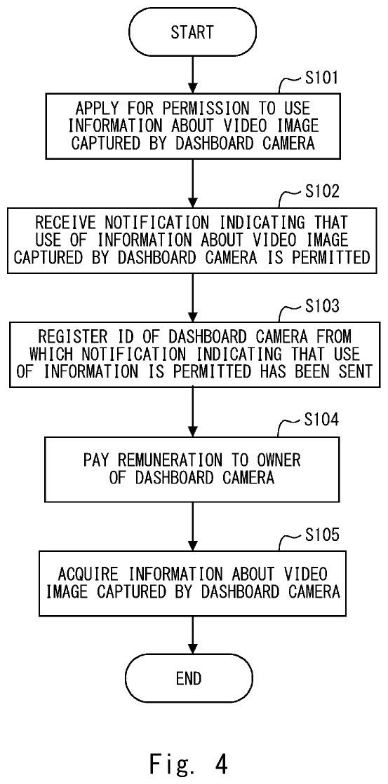

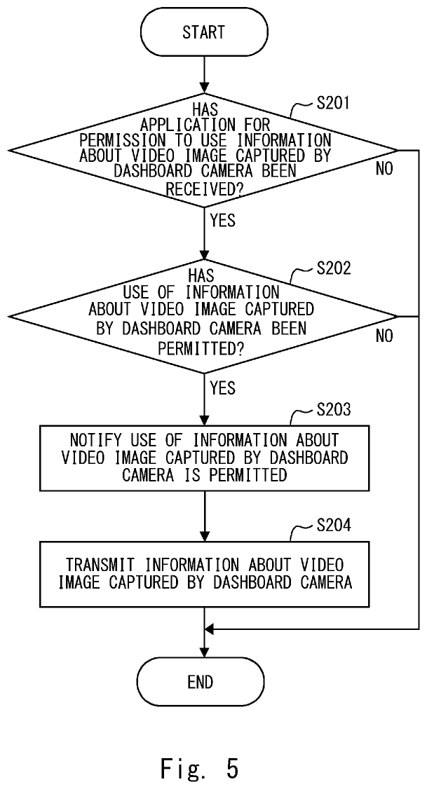

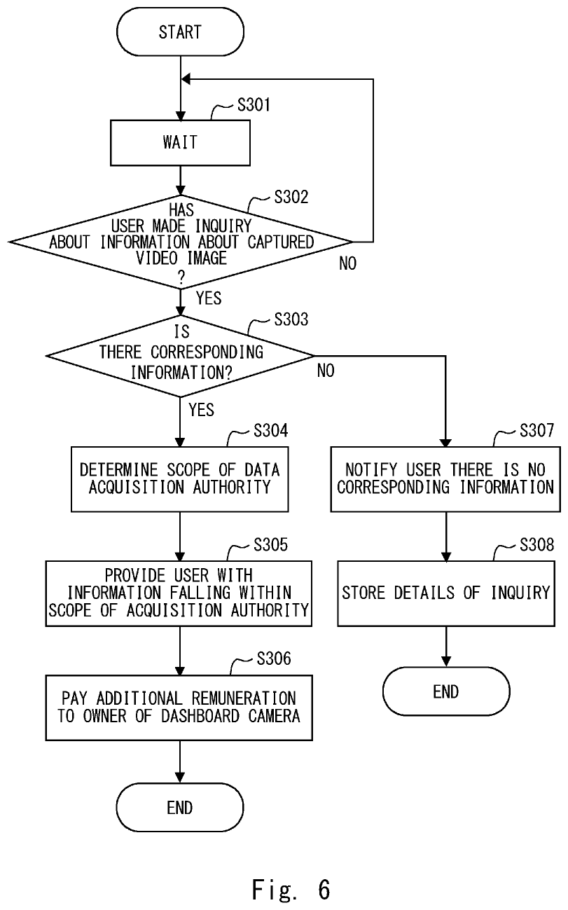

Next, an operation of the information providing system SYS1 will be described with reference to FIGS. 4, 5, and 6. FIG. 4 is a flowchart showing an operation of collecting information performed by the information providing apparatus 1. FIG. 5 is a flowchart showing an example of an operation of the dashboard camera. FIG. 6 is a flowchart showing an example of an operation of providing information performed by the information providing apparatus 1.

The example of the operation of collecting information performed by the information providing apparatus 1 will be first described with reference to FIG. 4. First, the permission application means 111 applies to an owner of a dashboard camera of each vehicle for permission to use information about the video image captured by the dashboard camera (Step S101).

After that, the notification reception means 112 receives, from the owner of the dashboard camera of each vehicle, a notification indicating that the use of the information about the video image captured by the dashboard camera is permitted (Step S102). For example, the notification reception means 112 receives, from the owner of each of the dashboard cameras DR1 to DRn, a notification indicating that the use of the information about the captured video image is permitted. The identification information of each of the dashboard cameras DR1 to DRn in which the use of the information about the captured video image has been permitted is stored, for example, in the storage means 15 (Step S103). The identification information of each of the dashboard cameras DR1 to DRn may be any identification information that specifies a provider of the captured video image, such as identification information of the dashboard camera itself, identification information of a SIM card or the like of communication means provided in the dashboard camera, and identification information of an individual account or the like of a driver which is input to the dashboard camera by using input means (not shown).

After Step S103, the payment means 14 pays a remuneration in an amount determined in accordance with a range of information that can be provided to a person (i.e., the owner of the dashboard camera) who has permitted provision of the information about the video image captured by the dashboard camera to a user (Step S104). Note that the payment means 14 may pay a remuneration not only to the owner of the dashboard camera but also to the provider of the captured video image specified in Step S103.

For example, the longer the capturing time period of a captured video image that can be provided to a user, the higher the remuneration. Further, the larger the capturing area of a captured video image that can be provided to a user, the higher the remuneration. Further, the greater the number of cameras capturing video images that can be provided to a user, the higher the remuneration. Further, the more frequently a video image that can be provided to a user is transmitted to the information providing apparatus 1, the more the real-time performance is improved and thus the higher the remuneration. Note that the amount of remuneration may be determined not only by the above conditions, but also by various other conditions. Further, the condition for determining the amount of remuneration may be one of various conditions or a combination of two or more of the various conditions.

After Step S104, the information acquisition means 113 acquires information about the captured video image of each of the dashboard cameras DR1 to DRn, for example, by radio communication (Step S105). The information about the captured video image of each of the dashboard cameras DR1 to DRn is stored, for example, in the storage means 15.

In this way, the information providing apparatus 1 pays a fixed remuneration to a provider of information about the captured video image regardless of whether or not the information about the captured video image has been actually provided to a user of the information providing system SYS1. By this configuration, it is highly likely that the number of providers of information about the captured video image increases, and therefore it is possible to efficiently collect information provided to a user of the information providing system SYS1.

Next, an example of the operation of each of the dashboard cameras DR1 to DRn will be described with reference to FIG. 5. The operation of the dashboard camera DR1 will be described below as a representative example.

In a case in which the dashboard camera DR1 or the owner of the dashboard camera DR1 has received an application for permission to use information about the captured video image from the information providing apparatus 1 (YES in Step S201), if the dashboard camera DR1 or the owner thereof permits the use of the information about the captured video image (YES in Step S202), the dashboard camera DR1 or the owner thereof notifies the information providing apparatus 1 that the use of the information about the captured video image is permitted together with the range of use of the information to be permitted (Step S203).

After that, the dashboard camera DR1 transmits the information about the captured video image to the information providing apparatus 1 at the set frequency (Step S204).

Note that if the dashboard camera DR1 or the owner thereof has not received an application for permission to use information about the captured video image from the information providing apparatus 1 (NO in Step S201), or if the dashboard camera DR1 or the owner thereof does not permit the use of the information about the captured video image (NO in Step S202), the processing of the dashboard camera DR1 ends.

Next, an example of the operation of providing information performed by the information providing apparatus 1 will be described with reference to FIG. 6.

First, the information output means 13 waits until a user of the information providing system SYS1 makes an inquiry about information about the captured video image (Step S301->NO in Step S302).

If the user of the information providing system SYS1 makes an inquiry about information about the captured video image (YES in Step S302), the information output means 13 retrieves the information which the user has made an inquiry about from pieces of information about the captured video image stored in the storage means 15 (Step S303).

If the information which the user has made an inquiry about is in the pieces of information about the captured video image stored in the storage means 15 (YES in Step S303), the information output means 13 determines the scope of the user's data acquisition authority (Step S304), and then provides the user with information that falls within the scope of the user's acquisition authority (Step S305).

For example, when a user is the police or an insurance company whose aim is to specify the cause of a traffic accident, the information output means 13 may provide details of the information about the captured video image which the police or the insurance company has made an inquiry about. On the other hand, when a user is a traffic information providing company or the like, it is preferable that the information output means 13 provide only information about traffic congestion from among pieces of information about the captured video image and that, for example, it does not provide the captured video image itself.

After Step S305, the payment means 14 pays an additional remuneration to the owner of the dashboard camera that has captured the video image related to the information provided to the user of the information providing system SYS1 (Step S306). Note that the payment of an additional remuneration for the provision of the captured video image is optional. It is not always necessary to pay an additional remuneration for each provision of the captured video image, and a normal amount (an amount in accordance with the fact that the owner has permitted the provision of the captured video image instead of the fact that the information has been actually provided to the user) of remuneration may be changed in accordance with the results of the actual provision of the captured video image. For example, the normal amount of remuneration may be increased as the number of provided captured video images increases or as the evaluation by a user who has received the provided captured video image becomes higher. In addition to the payment of an additional remuneration for provision of the captured video image, the normal amount of remuneration may be changed in accordance with the results of the actual provision of the captured video image.

Specifically, for example, when the captured video image has been provided to a user of the information providing system SYS1, the payment means 14 pays an additional remuneration to the owner of the dashboard camera that has captured the video image. Further, for example, when information of traffic congestion that does not include the captured video image has been provided to a user of the information providing system SYS1, the payment means 14 pays an additional remuneration to the owner of the dashboard camera that has captured the video image which was used as a basis for generating the information of traffic congestion.

Note that if there is no information which the user has made an inquiry about in the pieces of information about the captured video image stored in the storage means 15 (NO in Step S303), the information output means 13 notifies the user that there is no information corresponding to the information which the user has made an inquiry about (Step S307). Note that the details of the inquiry are stored, for example, in the storage means 15 (Step S308). By doing the above, when the information which the user has made an inquiry about is acquired later, this information can be provided to the user.

In this way, the information providing apparatus 1 according to this embodiment and the information providing system SYS1 according to this embodiment which includes this information providing apparatus 1 pay a fixed remuneration to a provider of information about the captured video image regardless of whether or not the information about the captured video image has been actually provided to a user of the information providing system SYS1. By this configuration, it is highly likely that the number of providers of information about the captured video image increases, and therefore it is possible to efficiently collect information provided to a user of the information providing system SYS1.

In this embodiment, a description has been given of an example in which the information output means 13 retrieves information which a user has made an inquiry about from pieces of information about the captured video image stored in the storage means 15, but the present disclosure is not limited thereto. The information output means 13 may retrieve the information which a user has made an inquiry about not only from the pieces of information about the captured video image stored in the storage means 15 but also from pieces of information about the captured video image stored in the storage means 24 of each of the dashboard cameras DR1 to DRn. In accordance with an inquiry from the information output means 13, each of the dashboard cameras DR1 to DRn may retrieve the target information from the pieces of information about the captured image video stored in the storage means 24 and transmit a result of the retrieval to the information providing apparatus 1.

In this case, the owner of each of the dashboard cameras DR1 to DRn may set, for example, in a storage area of the storage means 24 provided in the dashboard camera, the range of a write-protected storage area in which information about the captured video image that can be provided to a user is stored, or the period during which information about the captured video image that can be provided to a user is stored in the write-protected storage area.

Further, the amount of remuneration at this time may be determined in accordance with the range of the write-protected storage area or the period during which information about the captured video image is stored in the write-protected storage area. For example, the larger the range of the write-protected storage area or the longer the period during which information about the captured video image is stored in the write-protected storage area, the more unnecessary it becomes to secure the storage area of the information providing apparatus 1. Therefore, the amount of remuneration may be set to become higher the larger the range of the write-protected storage area or the longer such period. The amount of remuneration may be determined by using both the range of the write-protected storage area and the period during which information about the captured video image is stored in the write-protected storage area.

Note that the amount of remuneration paid by the payment means 14 is not limited to being determined by the conditions described above, and may be determined by various other conditions.

For example, the amount of remuneration may be determined in accordance with the time range of the captured video image that can be provided with respect to the information about the captured video image requested by a user of the information providing system SYS1. In other words, the amount of remuneration may be determined in accordance with the fact that the captured video image captured at the requested time can be provided with respect to the information about the captured video image captured at the time requested by a user of the information providing system SYS1, and further the length of the captured video image captured before and after the requested time which can be provided. Specifically, for example, when the user of the information providing system SYS1 requests the captured video image of a traffic accident E1, the remuneration may be set in accordance with the fact that the captured video image captured at the time when the traffic accident E1 has occurred can be provided, and further set to become higher as the length of the captured video image captured at the time before and after the traffic accident E1 has occurred which can be provided becomes longer.

Further, the amount of remuneration may be determined in accordance with the number per unit area of dashboard cameras for capturing a captured video image that can be provided to a user of the information providing system SYS1. For example, the smaller the number per unit area of dashboard cameras for capturing a captured video image that can be provided to a user of the information providing system SYS1, the more valuable the captured video image becomes. Therefore, the amount of remuneration may be set to become higher the smaller the number per unit area of such dashboard cameras.

Further, the remuneration amount may be determined in accordance with the range of a video image that has been actually captured by the dashboard camera as a captured video image that can be provided to a user of the information providing system SYS1. For example, the larger the range of the video image that has been actually captured by the dashboard camera as a captured video image that can be provided to a user of the information providing system SYS1, the more the captured video image is enriched. Therefore, the amount of remuneration may be set to become higher the larger the range of such video image.

In the above embodiment, a description has been given of an example in which the information providing apparatus 1 acquires information about the video image captured by the dashboard camera mounted on a vehicle, but the present disclosure is not limited thereto. The information providing apparatus 1 may acquire information about the video image captured by a smartphone or the like carried by a person. Alternatively, the information providing apparatus 1 may acquire information about the video image captured by a camera or the like mounted on a flying object such as a drone. That is, the information providing apparatus 1 only needs to acquire information about the video image captured by an image capturing apparatus held in a mobile body.

### (Hardware Configuration of Information Providing Function of Information Providing Apparatus 1)

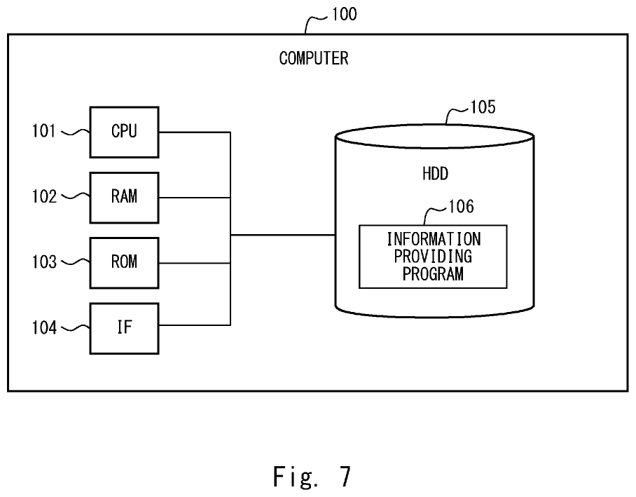

Note that the processing for providing information implemented by the information providing apparatus 1 can also be implemented by a general-purpose computer system. A brief description thereof will be given below with reference to FIG. 7.

FIG. 7 is a block diagram showing an example of the hardware configuration of an information providing function. A computer 100 includes, for example, a Central Processing Unit (CPU) 101, which is a control apparatus, a Random Access Memory (RAM) 102, and a Read Only Memory (ROM) 103. The computer 100 further includes an Inter Face (IF) 104, which is an interface with the outside, and a Hard Disk Drive (HDD) 105, which is an example of a nonvolatile storage device. Further, the computer 100 may include an input device (not shown) such as a keyboard and a mouse, or a display device (not shown) such as a display.

The HDD 105 stores an Operating System (OS) (not shown) and an information providing program 106. The information providing program 106 is a computer program in which the information providing processing according to this embodiment is implemented.

The CPU 101 controls, for example, various types of processing performed in the computer 100, access to the RAM 102, the ROM 103, the IF 104, and the HDD 105. In the computer 100, the CPU 101 loads the OS and the information providing program 106 stored in the HDD 105 and executes these. In this way, the computer 100 implements the information providing function of the information providing apparatus 1 according to this embodiment.

Although the disclosure made by the present inventors has been described in detail based on the embodiment, the present disclosure is not limited to the embodiment described above, and various modifications can be made without departing from the scope of the present disclosure, as a matter of course.

Although the present disclosure has been described as a hardware configuration in the above embodiment, the present disclosure is not limited thereto. In the present disclosure, any processing can also be implemented by causing a Central Processing Unit (CPU) to execute a computer program. The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Although the present disclosure has been described with reference to the embodiment, the present disclosure is not limited by the above. The configuration and details of the present disclosure may be modified in various ways as will be understood by those skilled in the art within the scope of the disclosure.

According to this embodiment, it is possible to provide an information providing apparatus and an information providing program that are suitable for efficiently collecting information to be provided to a user.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. An information providing apparatus comprising:
a notification reception unit configured to receive a notification indicating that provision of information about a captured video image of an image capturing apparatus to a user is permitted, the image capturing apparatus being held by a mobile body;
an information acquisition unit configured to acquire the information about the captured video image of the image capturing apparatus, provision of the captured video image to the user having been permitted;
an information output unit configured to provide, to the user who requests provision of the information about the captured video image acquired by the information acquisition unit, the information about the captured video image; and
a payment unit configured to pay a remuneration to an owner of the image capturing apparatus that has captured the video image, provision of the video image to the user having been permitted.

2. The information providing apparatus according to claim 1, wherein the payment unit is further configured to pay an additional remuneration to the owner of the image capturing apparatus that has captured the video image related to the information that has been provided to the user.

3. The information providing apparatus according to claim 1, wherein the payment unit is further configured to determine an amount of the remuneration to be paid to the owner in accordance with one or a combination of two or more of:
in a storage area of a storage provided in the image capturing apparatus, a range of a write-protected storage area in which the information about the captured video image that can be provided to the user is stored, or a period during which the information about the captured video image that can be provided to the user is stored in the write-protected storage area;
a capturing time period of the captured video image that can be provided to the user;
a capturing area of the captured video image that can be provided to the user;
a time range of the captured video image that can be provided with respect to the information about the captured video image requested by the user;
the number per unit area of the image capturing apparatuses, each of the image capturing apparatus capturing the captured video image that can be provided to the user;
a range of the video image that has been actually captured by the image capturing apparatus as the captured video image that can be provided to the user;
the number of cameras provided in the image capturing apparatus, the image capturing apparatus capturing the captured video image that can be provided to the user; and
a frequency of acquiring the information about the captured video image that can be provided to the user.

4. The information providing apparatus according to claim 1, wherein the payment unit is further configured to determine the amount of the remuneration to be paid to the owner in accordance with the number of cases in which the captured video image has been actually provided to the user or an evaluation by the user when the captured video image has been actually provided to the user.

5. A non-transitory computer readable medium storing an information providing program for causing a computer to:
receive a notification indicating that provision of information about a captured video image of an image capturing apparatus to a user is permitted, the image capturing apparatus being held by a mobile body;
acquire the information about the captured video image of the image capturing apparatus, provision of the captured video image to the user having been permitted;
provide, to the user who requests provision of the acquired information about the captured video image, the acquired information about the captured video image; and
pay a remuneration to an owner of the image capturing apparatus that has captured the video image, provision of the video image to the user having been permitted.
